(19) United States
(12) Patent Application Publication
(10) Pub. No.: US 2015/0102986 A1
(43) Pub. Date: Apr. 16, 2015

(54) DISPLAY APPARATUS AND FLICKER PREVENTION METHOD

(71) Applicant: AU OPTRONICS CORPORATION, HSIN-CHU (TW)

(72) Inventors: Chien-Chih LIU, HSIN-CHU (TW); Neng-Yi LIN, HSIN-CHU (TW)

(21) Appl. No.: 14/308,057

(22) Filed: Jun. 18, 2014

(30) Foreign Application Priority Data
Oct. 11, 2013 (TW) 102136796

(51) Int. Cl. G09G 3/36

(52) U.S. Cl. CPC G09G 3/3696; G09G 2330/028; G09G 2300/0478
USPC 345/87

(57) ABSTRACT

The display apparatus includes a LCD panel, a power module, a driving module, and a switch unit. The LCD panel includes several pixels. The power module is turned on to provide an operation voltage to the driving module based on a start signal. The power module includes a voltage stabilizing capacitor. The driving module includes a gate driver and a discharge resistor. The discharge resistor is connected between the voltage stabilizing capacitor and a ground terminal. The switch unit is electrically connected between the voltage stabilizing capacitor and the discharge resistor. When the switch unit is conducted, the voltage stabilizing capacitor is electrically connected to the discharge resistor through the switch unit, and residual electric charges in the voltage stabilizing capacitor are released to the ground terminal through the discharge resistor.

### RELATED APPLICATIONS

This application claims priority to Taiwan Application Serial Number 102136796, filed Oct. 11, 2013, which is herein incorporated by reference.

### BACKGROUND

1. Technical Field

The present disclosure relates to a display apparatus. More particularly, the present disclosure relates to a display apparatus capable of releasing residual electric charges.

2. Description of Related Art

A phenomenon that electric charges remain in the liquid crystal panels usually in large-sized panels, such as panels fabricated using advanced hyper-viewing angle (AHVA) technology, are powered off. As a result, the liquid crystal panels flicker when they are powered on next time. The reason the electric charges remain in a panel is that the power circuit provides a voltage source required by the driving circuit to drive the liquid crystal panel. During the powering off, the power circuit has discharged for too long a time so that electric charges in the power circuit flow back to the pixel capacitors in the liquid crystal panel via the wires along which the power circuit provides the voltage source and are stored. Hence, the electric charges remain in the liquid crystal panel.

FIG. 1 depicts a schematic diagram of a power circuit utilized in traditional applications. As shown in FIG. 1, a power circuit 100 includes a power conversion unit 110, a control unit 130, an input terminal Vᵢₙ, at least one first output voltage terminal AVDD, and at least one second output voltage terminal AVEE. The power circuit 100 receives an input voltage via the input terminal Vᵢₙ and transmits the input voltage to the power conversion unit 110 and the control unit 130. The power circuit 100 respectively provide different output voltages V₁, V₂, which are converted from the input voltage by the power conversion unit 110 to a driving circuit (not shown in the figure) via the first output voltage terminal AVDD and the second output voltage terminal AVEE. The first output voltage terminal AVDD and the second output voltage terminal AVEE are electrically connected to a capacitor C₁ and a capacitor C₂, respectively. The capacitor C₁ and the capacitor C₂ are utilized for stabilizing the output voltage V₁ and the output voltage V₂. When the liquid crystal panel is powered off, the power circuit 100 will simultaneously release residual electric charges in the capacitor C₁ and the capacitor C₂.

However, the capacitors of the power circuit 100 release charges too slow to result in the residual electric charges in the capacitor C₁ and the capacitor C₂ flow back to a liquid crystal panel (not shown in the figure) connected to the first output voltage terminal AVDD and the second output voltage terminal AVEE. Hence, the electric charges remain in the liquid crystal panel after the power cuts off. The liquid crystal panel thus may flickers as it is powered on again because of the residual electric charges in the liquid crystal panel.

For the forgoing reasons, there is a need for solving the aforementioned problem by providing a display apparatus and a flicker prevention method to allow the power circuit that provides the voltage to rapidly release the residual electric charges in the voltage stabilizing capacitor of the_power circuit so as to prevent the electric charges from flowing back and remaining in the liquid crystal display when the liquid crystal panel is powered off.

### SUMMARY

In order to solve the aforementioned problem, the present disclosure provides a display apparatus. When the display apparatus is powered off, residual electric charges in a voltage stabilizing capacitor of a power module are rapidly released so that the electric charges do not remain in a liquid crystal panel to avoid the flicker phenomenon when the display apparatus is powered on next time.

One aspect of the present disclosure is to provide a display apparatus. The display apparatus includes a liquid crystal panel, a power module, a driving module, and a switch unit. The liquid crystal panel includes several pixels. The power module receives a start signal. The power module is turned on to provide an operation voltage to the driving module based on the start signal. The power module includes a voltage stabilizing capacitor for stabilizing the operation voltage. The driving module includes a gate driver and a discharge resistance. The gate driver is driven by the operation voltage to conduct the pixels. The discharge resistor is coupled to the voltage stabilizing capacitor and a ground terminal. The switch unit is electrically connected to the voltage stabilizing capacitor and the discharge resistor. The voltage stabilizing capacitor is electrically connected to the discharge resistor through the switch unit when the switch unit is conducted so that residual electric charges in the voltage stabilizing capacitor are released to the ground terminal through the discharge resistor.

Another aspect of the present disclosure is to provide a flicker prevention method applied to the foregoing display apparatus. The method includes: detecting an input voltage; performing an image clearing process when the input voltage is lower than a lowest voltage required for turning on the power module; conducting the switch unit so that the residual electric charges in the voltage stabilizing capacitor are released through the discharge resistor.

In summary, according to the above embodiments, the switch unit is conducted to allow the voltage stabilizing capacitor in the power module to be electrically connected to the discharge resistor via the switch unit when the display apparatus is powered off or restarted. The process of releasing the residual electric charges in the voltage stabilizing capacitor is thus accelerated to prevent the residual electric charges from remaining in the liquid crystal panel so as to avoid the flicker phenomenon when the display apparatus is powered on next time. In addition, the discharge resistor is one of the programming resistors in the programming mechanism inside the IC chip itself, thus no extra cost being added.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1 depicts a schematic diagram of a power circuit utilized in traditional applications; and

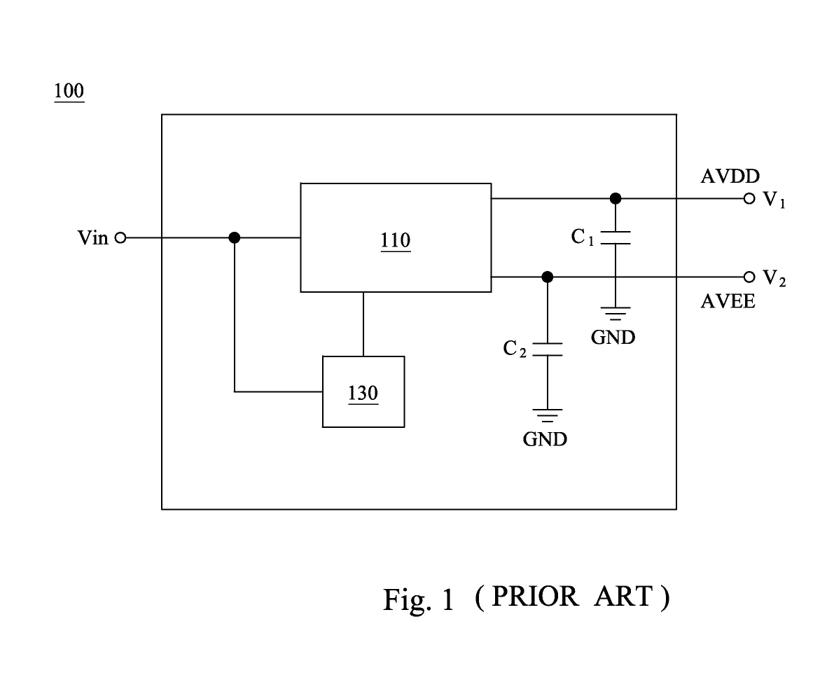

FIG. 2a depicts a schematic diagram of a display apparatus according to one embodiment of this disclosure;

FIG. 2b depicts a schematic diagram of programming resistors according to one embodiment of this disclosure;

FIG. 3 depicts a schematic diagram of a display apparatus according to another embodiment of this disclosure; and

FIG. 4 depicts a flowchart of flicker prevention method according to one embodiment of this disclosure

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

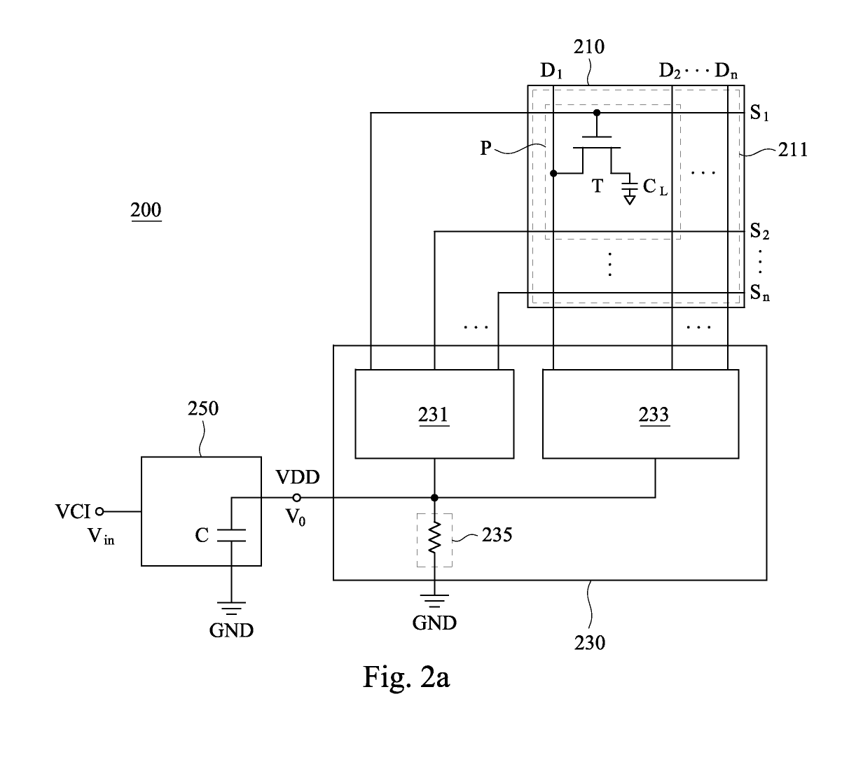

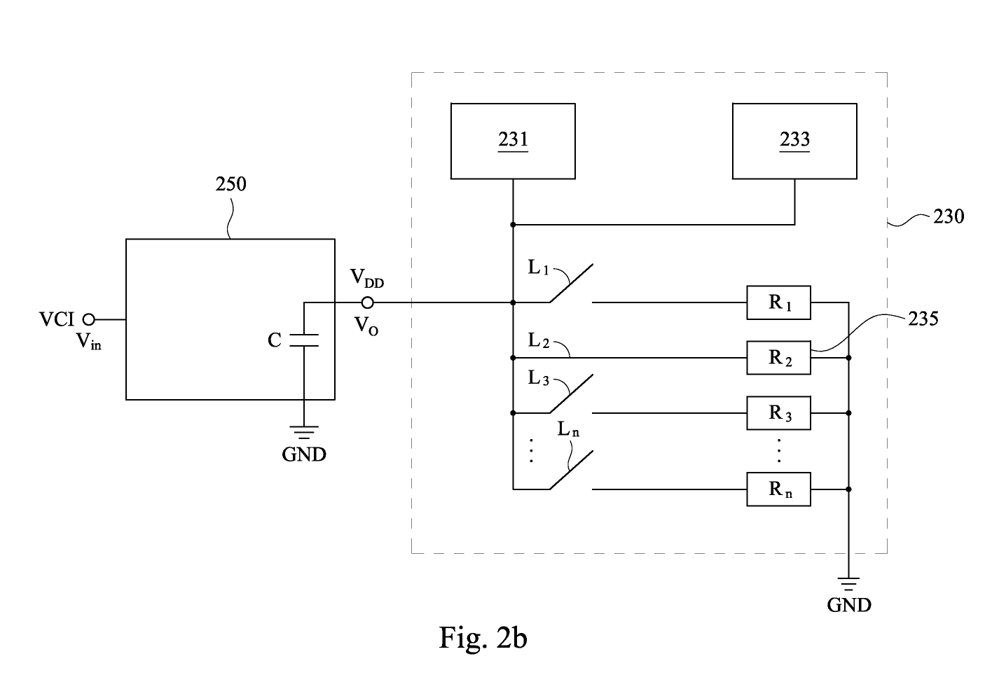

FIG. 2a depicts a schematic diagram of a display apparatus 200 according to one embodiment of this disclosure. As shown in FIG. 2a, a display apparatus 200 includes a liquid crystal panel 210, a driving module 230, and a power module 250. The liquid crystal panel 210 includes a pixel matrix 211, having several pixels P, several scan lines S₁, S₂, . . . , Sₙ and several data lines D₁, D₂, . . . , Dₙ. The scan lines S₁-Sₙ intersects with the data lines D₁-Dₙ.

The driving module 230 includes driving circuits, such as a gate driver 231, a source driver 233, etc. The gate driver 231 is electrically connected to the liquid crystal panel 210 via the scan lines S₁-Sₙ and configured for driving pixel transistors T connected to the scan lines S₁-Sₙ. The source driver 233 is electrically connected to the liquid crystal panel 210 via the data lines D₁-Dₙ and configured for providing a data voltage to pixel electrodes connected to each of the data lines D₁-Dₙ.

The power module 250 includes an input terminal Vᵢₙ, at least one output terminal Vₒ, and at least one voltage stabilizing capacitor C. In the present embodiment, a number of the output terminal and a number of the voltage stabilizing capacitor are both one, but the present embodiment is not limited to the numbers as described. The input terminal Vᵢₙ of the power module 250 is configured for receiving an input voltage VCI. The output terminal Vₒ is configured for providing an operation voltage VDD required for turning on the driving module 230. The voltage stabilizing capacitor C is electrically connected between the output terminal Vₒ and a ground terminal GND and configured for stabilizing the operation voltage VDD at the output terminal V₀.

When the power of the display apparatus 200 is turned on, a host system or an operation interface (not shown in the figure) connected to the display apparatus 200 provides the input voltage VCI to the display apparatus 200 through an operation (such as pressing the power button or turning on the power switch). The power module 250 receives the input voltage VCI via the input terminal Vᵢₙ and converts the input voltage VCI into the operation voltage VDD required by the driving module 230, then provides the operation voltage VDD to the driving module 230 via the output terminal Vₒ.

Moreover, the output terminal Vₒ of the power module 250 is connected to the voltage stabilizing capacitor C, and the voltage stabilizing capacitor C has the property of accumulating electric charges. Hence, during the process the operation voltage VDD is transmitted from the output terminal Vₒ, the voltage stabilizing capacitor C will charge or discharge if there is any transient change in the operation voltage VDD. As a result, the operation voltage VDD is maintained at a voltage level required by the driving module 230.

The gate driver 231 in the driving module 230 is turned on after receiving the operation voltage VDD, then the gate driver 231 outputs a driving signal to the pixels P in the liquid crystal panel 210 sequentially via each of the scan lines S₁-Sₙ and conducts the pixel transistors T. The source driver 233 is also turned on after receiving the operation voltage VDD, and outputs the data voltage to source electrodes of the pixel transistors T sequentially via each of the data lines D₁-Dₙ. When each of the pixel transistors T is conducted, the data voltage is written into a pixel capacitor C_{L} in the pixel P through the each of the pixel transistors T. As a result, a pixel voltage is formed and stored in each of the pixel capacitors C_{L}.

When the power of the display apparatus 200 is turned off, the external host system or the external operation interface (not shown in the figure) connected to the display apparatus 200 stops providing the input voltage VCI through an operation (such as pressing the stop button or turning off the power switch). The input voltage VCI received by the power module 250 via the input terminal Vᵢₙ gradually decreases until reaches zero. At this moment, the gate driver 231 turns the pixel transistors Tin the liquid crystal panel 210 on through each of the san lines S₁-Sₙ so that residual electric charges stored in each of the pixel capacitors C_{L} can be discharged through a grounding path. Hence, the residual image on the liquid crystal panel 210 can be eliminated. The discharge process by the pixel capacitors C_{L} is called an image clearing process. After the driving module 230 completes the image clearing process, the power module 250 starts performing a discharge process, that is, releasing residual charges in the voltage stabilizing capacitor C.

The size of a capacitor component is related to its voltage stabilizing effect. The greater the capacitance value of a capacitor component is, the better voltage stabilizing effect the capacitor component has. However, the discharge time for a capacitor component has a positive correlation with the magnitude of the capacitance value. Hence, the larger the size of a liquid crystal panel is, the higher the operation voltage required by the driving module is because the number of signals has to be driven by the driving module is increased. When the operation voltage provided by the power module is increased, the capacitor component having a greater capacitance value (the device size will be larger correspondingly) is required to provide a better voltage stabilizing effect.

Therefore, when the power module 250 performs the discharge process, the discharge time required by the voltage stabilizing capacitor C is increased. If the discharge time by the voltage stabilizing capacitor C is not sufficient or the discharge rate is too slow, electric charges in the power module 250 (such as the residual electric charges in the voltage stabilizing capacitor C) will flow back to the liquid crystal panel 210 via the output terminal Vₒ and wires connected between the output terminal Vₒ and the liquid crystal panel 210 and are stored in the pixel capacitors C_{L}.

In order to avoid an excessive discharge time by the voltage stabilizing capacitor C in the power module 250, as shown in FIG. 2a, the display apparatus 200 includes a discharge resistor 235 coupled between the voltage stabilizing capacitor C and the ground terminal GND according to one embodiment of the present disclosure. The discharge resistor 235 provides a discharge path for the power module 250. With such a configuration, not only can the power module 250 release the electric charges through grounding the voltage stabilizing capacitor C, but the discharge resistor 235 can also accelerate the discharge process when the power module 250 performs the discharge process. The time required by the discharge process performed by the power module 250 is shortened so as to avoid that the electric charges in the power module 250 (such as the residual electric charges in the voltage stabilizing capacitor C) flow back to the liquid crystal panel 210.

It is noted that the power module is usually fabricated on a flexible printed circuit (FPC) board, and the gate driver and the source driver of the driving module are fabricated on an IC chip. We disclose several embodiments for disposing the discharge resistor. In one embodiment, the discharge resistor is disposed in the power module and the discharge resistor is directly connected to the voltage stabilizing capacitor. In another embodiment, the discharge resistor is disposed in the IC chip and the discharge resistor is connected to the voltage stabilizing capacitor via wires between the flexible printed circuit board and the IC chip.

In one embodiment, since the area of the flexible printed circuit board is limited, disposition of the extra resistor will occupy the layout area of the power module and increase the cost for disposing physical devices. Consequently, the preferred method is to dispose the discharge resistor in the IC chip. For example, the programming mechanism in the IC chip itself may be utilized so that one programming resistor of several programming resistors may serve as a discharge resistor without actually adding a resistor. For example, the programming mechanism may be implemented with a multi-time programmable (MTP) non-volatile memory. In this manner, only an internal programming wire connected to the programming resistor that serves as the discharge resistor needs to be added without resulting in extra cost and increasing the area occupied.

In one embodiment of the present disclosure, the discharge resistor 235 is disposed in the IC chip. It is noted that the discharge resistor 235, the gate driver 231, and the source driver 233 are all disposed in the IC chip. FIG. 2b depicts a schematic diagram of programming resistors according to one embodiment of this disclosure. As shown in FIG. 2b, the IC chip has several programming resistors R₁-Rₙ inside it. Each of the programming resistors R₁-Rₙ has a resistance value different from resistor values of the other programming resistors, and one internal programming wire of several internal programming wires 1_{—1}-Lₙ can be conducted through a programming mechanism (such as the multi-time programming (MTP)) so as to couple one of the programming resistors R₁-Rₙ to the voltage stabilizing capacitor C. One of the programming resistors R₁-Rₙ may be selected to be the discharge resistor 235 depending on user's design. For example, in the embodiment shown in FIG. 2b, the programming wire L₂ is conducted and the programming resistor R₂ is selected to be the discharge resistor 235 so that the programming resistor R₂ is coupled to the voltage stabilizing capacitor C via the internal programming wire L₂. With such a configuration, no extra cost is caused because of the disposition of the discharge resistor 235 in the display apparatus 200.

The selection of the aforementioned programming resistors R₁-Rₙ may be based on the discharge voltage and the required discharge rate during the discharge process, and one of the programming resistors R₁-Rₙ is selected to be the discharge resistor 235 in FIG. 2a. For example, resistance values of the programming resistors R₁-Rₙ are respectively 1000 ohms, 5000 ohms, 10000 ohms, etc. The programming resistor R₁ having the resistance value of 1000 ohms has a relatively rapid discharge rate but can only endure a lower discharge voltage. Conversely, the programming resistor Rₙ having the resistance value of 100000 ohms has a relatively slow discharge rate but can endure a higher discharge voltage. In the embodiment shown in FIG. 2b, the programming resistor R₂ is selected as the programming resistor 235, but the disclosure is not limited in this regard. In other embodiments, resistors R₁-Rₙ having different resistance values from those disclosed in the embodiment shown in FIG. 2b may be selected as required by practical needs.

Although disposing the discharge resistor to couple to the voltage stabilizing capacitor will shorten the time required by the discharge process performed by the power module, the operation voltage will generate a current in the discharge path of the discharge resistor so as to cause unnecessary power consumption when the power module provides the operation voltage for the driving module. Furthermore, since a time constant is proportional to the magnitude of a capacitance value or a resistance value, the time required by the discharge process performed by the power module is shortened if the resistance value of the discharge resistor becomes smaller. However, since power is equal to the square of voltage divided by a value of the resist, that is, more power consumption is generated if the resistance value of the discharge resistor becomes smaller.

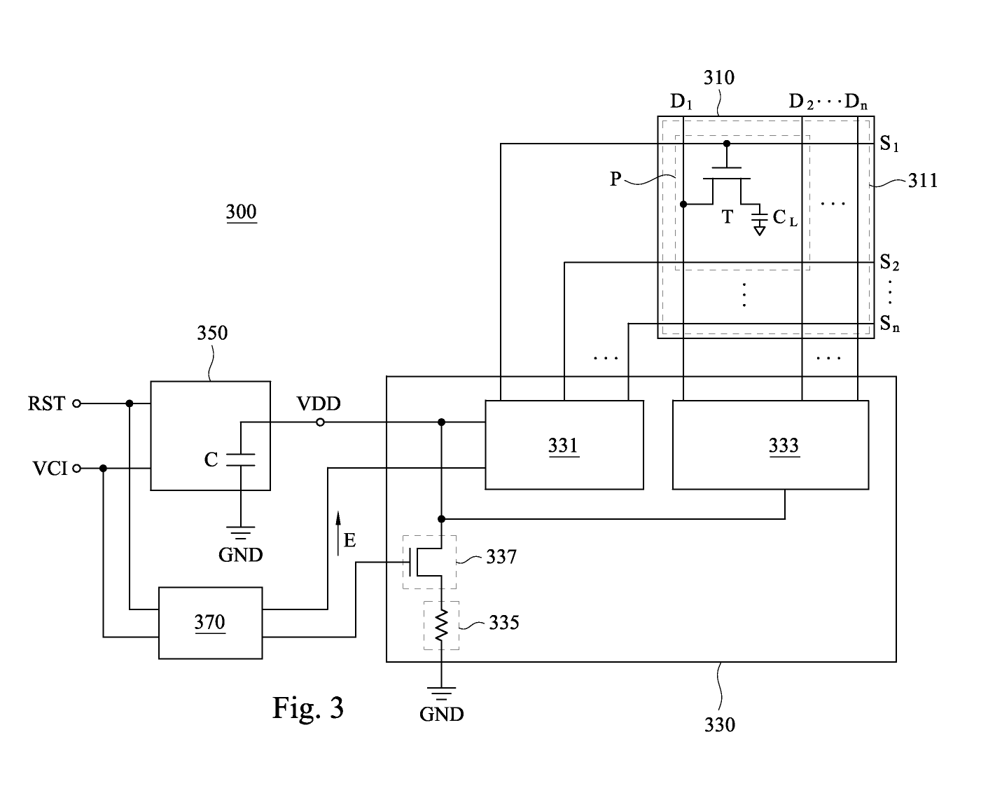

In order to allow the power module to rapidly release the electric charges stored in the voltage stabilizing capacitor when the display apparatus is powered off without causing the extra power consumption when the display apparatus is powered on, another embodiment of the present disclosure is provided with reference to FIG. 3. FIG. 3 depicts a schematic diagram of a display apparatus 300 according to another embodiment of this disclosure. Similarly, as shown in FIG. 3, a display apparatus 300 includes a liquid crystal panel 310, a driving module 330, and a power module 350. Similarly, the liquid crystal panel 310 comprises a pixel matrix 311 constituted by several pixels P formed from several scan lines S₁, S₂, . . ., Sₙ and several data lines D₁, D₂, . . . , Dₙ crossing several scan lines S₁, S₂, . . . , Sₙ. The driving module 330 comprises a gate driver 331, a source driver 333, and a discharge resistor 335. The discharge resistor 335 is coupled between a voltage stabilizing capacitor C and a ground terminal GND. The gate driver 331, the source driver 335, and the discharge resistor 335 are all disposed on an IC chip. Similarly, the discharge resistor 335 is one of programming resistors selected by a programming mechanism in the IC chip (for example, see FIG. 2b). To simplify matters, only the selected programming resistor is depicted.

In addition, the display apparatus 300 further includes a switch unit 337 and a control module 337. The switch unit 337 is coupled between the voltage stabilizing capacitor C and the discharge resistor 335. The switch unit 337 may be a metal-oxide-semiconductor field-effect transistor or other switching integrated circuit (IC), but the present embodiment is not limited in this regard. The control module 370 controls the switch unit 337 to conduct so that the voltage stabilizing capacitor C is electrically connected to the discharge resistor 335 via the switch unit 337. Residual charges in the voltage stabilizing capacitor C are thus released to the ground terminal GND through the discharge resistor 335.

Additionally, the control module 370 is electrically connected to an input terminal of the power module 350 to detect an input voltage VCI so as to determine when the switch unit 337 is conducted. When the display apparatus 300 is in an operating state (such as the display apparatus 300 displaying a picture), the power module 350 receives the input voltage VCI and converts the input voltage VCI into an operation voltage VDD. The operation voltage VDD is provided to the gate driver 331 and the source driver 333 to drive the liquid crystal panel 310 so as to display pictures. The driving method may be referred to the aforementioned embodiment, and a description in this regard is not provided.

During this period, the input voltage VCI is at a high voltage level (such as 5.2 volts), the control module 370 will control the switch unit 337 to cut off so that the voltage stabilizing capacitor C is not electrically connected to the discharge resistor 335. Hence, no extra power consumption is caused when the display apparatus 300 works in a normal state.

Furthermore, the control module 370 will detect whether the input voltage VCI is lower than a threshold voltage so as to determine whether to conduct the switch unit 327. The above threshold voltage represents the lowest voltage (such as 2 volts) required for turning on the power module 350. When the input voltage VCI is higher than or equal to the threshold voltage, the display apparatus 300 is in the operating state. The control module 370 thus controls the switch unit 337 to cut off so that the voltage stabilizing capacitor C is not electrically connected to the discharge resistor 335 to avoid the unnecessary power consumption.

When the display apparatus 300 is powered off, the input voltage VCI will gradually decrease. When the control module 370 detects that the input voltage VCI is lower than the threshold voltage, the control module 370 controls the switch unit 337 to conduct so that the voltage stabilizing capacitor C is electrically connected to the discharge resistor 335 via the switch unit 337.

The residual electric charges in the voltage stabilizing capacitor C are thus released to the ground terminal GND through the discharge resistor 335, that is, a discharge process is performed by the power module 350.

In addition, before the control module 370 controls the switch unit 337 to be conducted, the control module 370 will generate a control signal E to the gate driver 331 in advance if the input voltage VCI is lower than the threshold voltage. The control signal E controls the gate driver 331 to conduct all pixel transistors T in the liquid crystal panel 310 so as to perform an image clearing process, that is, to release residual electric charges in all pixel capacitors C_{L}. After that, the control module 370 controls the switch unit 337 to be conducted so as to perform the discharge process by the power module 350.

Specifically, the method for releasing the residual electric charges in all the pixel capacitors, namely the method for performing the image clearing process, may be to connect a common electrode coupled to each of the pixel capacitors to the ground terminal. Hence, each of the pixel capacitors is allowed to release the residual charges to the ground terminal. However, such a method is only an example method of the present embodiment, the present embodiment is not limited to the specific method for releasing the residual electric charges of the pixel capacitors as described.

Additionally, not only can the control module 370 determine whether to conduct the switch unit 337 based on whether the input voltage VCI is lower the threshold voltage, but the control module 370 can also determine whether to conduct the switch unit 337 based on a start signal RST received by the power module 350. The start signal RST is used for turning on the power module 350. That is, the power module 350 is turned off first when the start signal RST is enabled. Then, the input voltage VCI is re-provided by an external host system or an external operation interface (not shown in the figure) connected to the display apparatus 300. Since the power module 350 is turned off, the switch unit 337 needs to be conducted to allow the voltage stabilizing capacitor C to rapidly release the residual electric charges. In this manner, the control module 370 will control the switch unit 337 to conduct when the control module 370 detects that the start signal RST is enabled. The voltage stabilizing capacitor C is thus electrically connected to the discharge resistor 335 via the switch unit 337 so that the discharge process is performed by the power module 350 afterwards. Similarly, the control module 370 will perform the image clearing process before the switch unit 337 is conducted. Since the flow is provided in the above disclosure, a description in this regard is not provided.

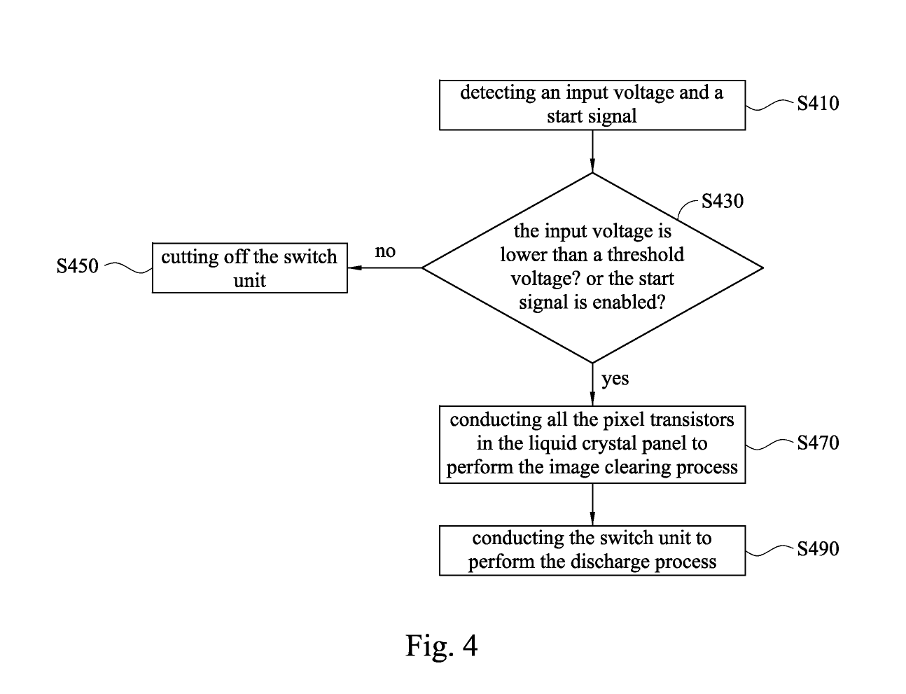

FIG. 4 depicts a flowchart of flicker prevention method according to one embodiment of this disclosure. To simplify and clarify matters, a description is provided with reference to the display apparatus in FIG. 3. In step 410, the control module 370 detects an input voltage VCI and a start signal RST. Then, in step 430, determine whether the input voltage VCI is lower than a threshold voltage (whether the input voltage VCI is lower than the lowest voltage required for turning on the power module 350) or whether the start signal RST is enabled (whether to turn on the power module 350). If the input voltage VCI is not lower than the threshold voltage and the start signal RST is not enabled, go to step 450. The control module 370 controls the switch unit 337 to cut off so that no extra power consumption is caused when the display apparatus 300 works in a normal state.

If the input voltage VCI is lower than the threshold voltage or the start signal RST is enabled, go to step 470. The control module 370 controls all the pixel transistors T in the liquid crystal panel 310 to conduct through the gate driver 331 to perform the image clearing process so as to release the residual electric charges in all the pixel capacitors C_{L}. After that, go to step 490, the control module 370 controls the switch unit 337 to conduct to allow the voltage stabilizing capacitor C to be electrically connected to the discharge resistor 335 via the switch unit 337. The residual electric charges in the voltage stabilizing capacitor C are thus released to the ground terminal GND via the discharge resistor 335. That is, the discharge process is performed by the power module 350. Therefore, the residual electric charges in the voltage stabilizing capacitor C are prevented from flowing back to the liquid crystal panel 310 via wires and being stored in the pixel capacitors C_{L} through the acceleration of releasing the residual electric charges in the voltage stabilizing capacitor C. As a result, the phenomenon that the display apparatus 300 flickers when it is powered on next time is avoided.

According to the above embodiments of the present disclosure, the switch unit is conducted through the control module to allow the voltage stabilizing capacitor in the power module to be electrically connected to the discharge resistor via the switch unit when the display apparatus is powered off or restarted. The process of releasing the residual electric charges in the voltage stabilizing capacitor is thus accelerated to prevent the residual electric charges from flowing back to the liquid crystal panel via the wires so as to avoid the flicker phenomenon when the display apparatus is powered on next time. In addition, no extra power consumption is generated when the display apparatus is in the operating state. In addition to that, the discharge resistor is one of the programming resistors in the programming mechanism inside the IC chip itself, thus no extra cost being added.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A display apparatus comprising:
a liquid crystal panel comprising a plurality of pixels;
a power module receiving a start signal, the power module being turned on to provide an operation voltage based on the start signal, the power module comprising a voltage stabilizing capacitor for stabilizing the operation voltage;
a driving module comprising a gate driver and a discharge resistance, the gate driver being driven by the operation voltage to conduct the pixels, the discharge resistor being coupled to the voltage stabilizing capacitor and a ground terminal; and
a switch unit being electrically connected to the voltage stabilizing capacitor and the discharge resistor, the voltage stabilizing capacitor being electrically connected to the discharge resistor through the switch unit when the switch unit is conducted so that residual electric charges in the voltage stabilizing capacitor are released to the ground terminal through the discharge resistor.

2. The display apparatus of claim 1, further comprising a control module, configured for detecting an input voltage of the power module.

3. The display apparatus of claim 2, wherein the control module conducts the switch unit when the input voltage is lower than a lowest voltage required for turning on the power module.

4. The display apparatus of claim 3, wherein the control module controls all pixel transistors to be conducted through the gate driver so as to perform an image clearing process before the control module conducts the switch unit.

5. The display apparatus of claim 1, further comprising a control module, configured for detecting the start signal.

6. The display apparatus of claim 5, wherein the control module conducts the switch unit when the start signal is enabled.

7. The display apparatus of claim 6, wherein the control module controls all pixel transistors to be conducted through the gate driver so as to perform an image clearing process before the control module conducts the switch unit.

8. The display apparatus of claim 1, wherein the driving module comprises a plurality of resistors, each of the resistors has a resistance value different from resistance values of the other resistors, one of the resistors is selected to be the discharge resistor and coupled to the switch unit.

9. A flicker prevention method applied to the display apparatus of claim 1, the method comprising:
detecting an input voltage of the power module;
performing an image clearing process when the input voltage is lower than a lowest voltage required for turning on the power module; and
conducting the switch unit so that the residual electric charges in the voltage stabilizing capacitor are released through the discharge resistor.

10. The method of claim 9, wherein the method further comprises the following steps before the switch unit is conducted:
detecting the start signal; and
performing the image clearing process when the start signal is enabled.
